(19) United States
(12) Patent Application Publication
(10) Pub. No.: US 2018/0343877 A1
(43) Pub. Date: Dec. 6, 2018

(54) CRISP MEAT CHIP AND SYSTEM AND METHOD FOR MAKING THE SAME

(71) Applicant: Land O' Frost, Inc., Munster, IN (US)

(72) Inventors: David A. Van Eekeren, Western Springs, IL (US); Edward J. Kleine, Beecher, IL (US)

(21) Appl. No.: 15/996,344

(22) Filed: Jun. 1, 2018

Related U.S. Application Data
(60) Provisional application No. 62/513,724, filed on Jun. 1, 2017.

(51) Int. Cl. A23B 4/03; A23L 13/60; A23L 5/10; A23B 4/07

(52) U.S. Cl. CPC A23B 4/031; A23L 13/67; A23V 2300/20; A23B 4/07; A23V 2300/10; A23L 5/17

(57) ABSTRACT

A crisp meat chip and method and system for making such a meat chip, the meat chip having rippled opposed surfaces, the method including creating a meat log, cooking the meat log, cooling the cooked meat log degrees Fahrenheit, deep chilling the meat log, slicing the meat log into rippled meat slices, drying the meat slices using an air impingement oven and cooling the dried meat slices.

### CROSS REFERENCE TO RELATED APPLICATIONS

This application claims the benefit of U.S. Provisional Application No. 62/513,724, titled Crisp Meat Chip and System and Method for Making the Same, filed Jun. 1, 2017, and specifically incorporates by reference herein the entirety of the contents of that application.

### BACKGROUND OF THE INVENTION

The description that follows relates to a new crisp meat chip and a method and system for making such a meat chip.

Snack foods that can be easily transported, stored without refrigeration and eaten without silverware are popular for their convenience. Crisp chips, traditionally made from potatoes, are one such widely popular type of snack. However, traditional potato chips are often high in calories, carbohydrates, fat and cholesterol. Meat and meat based snacks are popular for their appealing flavor, high protein content and low carbohydrate content. The nutritional attributes of meat and meat based snacks fulfill certain popular high-protein, low-carbohydrate diets and these attributes are desirable to consumers who follow such diets. Non-fried meats and lean meats such as chicken, turkey and pork are particularly desirable to consumers who are also seeking a low-fat diet. Many uncured meat products need to be refrigerated, limiting their portability and convenience as a snack. However, some do not. One such popular meat based snack is jerky, which is most commonly made from beef, but can also be made from turkey, chicken, pork, or other animal proteins. However, jerky is chewy and tough and lacks the crisp texture of a chip. Thus, a need exists for a meat based snack with high-protein content and low-carbohydrate and low-fat content that has the crisp tactile appeal of a traditional crisp chip and an efficient process and system for making the same.

### SUMMARY

In one aspect, the present disclosure provides for a crisp meat chip. The crisp meat chips according to the disclosure have a first side with a first rippled surface and a second side opposite the first side also having a rippled surface and a circumferential edge connecting the first surface and the second surface. The crisp meat chips have a thickness between the first surface and the second surface of approximately 0.01-0.05 inches and the chips fracture when displaced approximately 0.5 to 3.0 mm under 200 to 600 grams of force applied using a ¼ inch rounded end probe.

In certain embodiments the crisp meat chips have a diameter of approximately 0.75-1.50 inches and such crisp meat chips contains 1.0-7.0 g fat and 12-23 g protein per ounce.

In another aspect the present disclosure provides a method for making crisp meat chips. The disclosed method includes the following steps: creating a meat log; cooking the meat log; cooling the cooked meat log to approximately 40 degrees Fahrenheit; deep chilling the meat log to approximately 18-26 degrees Fahrenheit; slicing the meat log into ripple cut meat slices; drying the meat slices using an air impingement oven; and cooling the meat slices.

In another aspect, the present disclosure provides a method for making crisp meat chips including the following steps: creating a meat log by filling a casing with a meat mixture comprised of meat, water and liquid or dry ingredients; cooking the meat log; cooling the cooked meat log to approximately 40 degrees Fahrenheit; deep chilling the meat log to approximately 18-26 degrees Fahrenheit; removing the casing from the meat log; slicing the meat log into ripple cut meat slices approximately 0.03-0.15 inches thick; drying the meat slices using a air impingement oven; and cooling the meat slices in a rotary cooling drum, resulting in a meat chip approximately 0.01-0.05 inches thick.

In another aspect, the disclosure provides for rippled crisp meat chips approximately 0.01-0.05 inches thick and fracture between when displaced approximately 0.5 to 3.0 mm under 200 to 600 grams of force applied using a ¼ inch rounded end probe, produced by a process including the following steps: creating a meat log by filling a casing with a meat mixture comprised of meat, water and liquid or dry ingredients; cooking the meat log in a smokehouse; cooling the cooked meat log to approximately 40 degrees Fahrenheit; removing the casing from the meat log; deep chilling the meat log to 20-22 degrees Fahrenheit; slicing the meat log into ripple cut meat slices approximately 0.03-0.15 inches thick; drying the meat slices using a rotary drum air impingement oven; and cooling the meat slices in a rotary cooling drum, resulting in a meat chip approximately 0.01-0.05 inches thick.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

Illustrative and exemplary embodiments of the invention are described in further detail below with reference to and in conjunction with the figures.

FIG. 1A shows exemplary crisp meat chips according to one aspect of the invention.

FIG. 1B shows a side view of a crisp meat chip according to the present invention.

FIG. 2 is a flowchart of an exemplary method for making crisp meat chips according to the present invention.

FIG. 3A is schematic diagram of equipment comprising a system for making crisp meat chips according to the present invention.

FIG. 3B is schematic diagram of equipment, including a hopper, comprising a system for making crisp meat chips according to the present invention.

FIG. 4 is an image of a known rotary air impingement oven which can be used in making crisp meat chips according to an embodiment of the present invention.

FIG. 5 is a perspective view of slices of meat prior to heating during an intermediate stage in the process for making crisp meat chips according to the present invention.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the disclosure is intended to cover all such embodiments that may fall within the scope of the appended claims, either literally or under the doctrine of equivalents.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

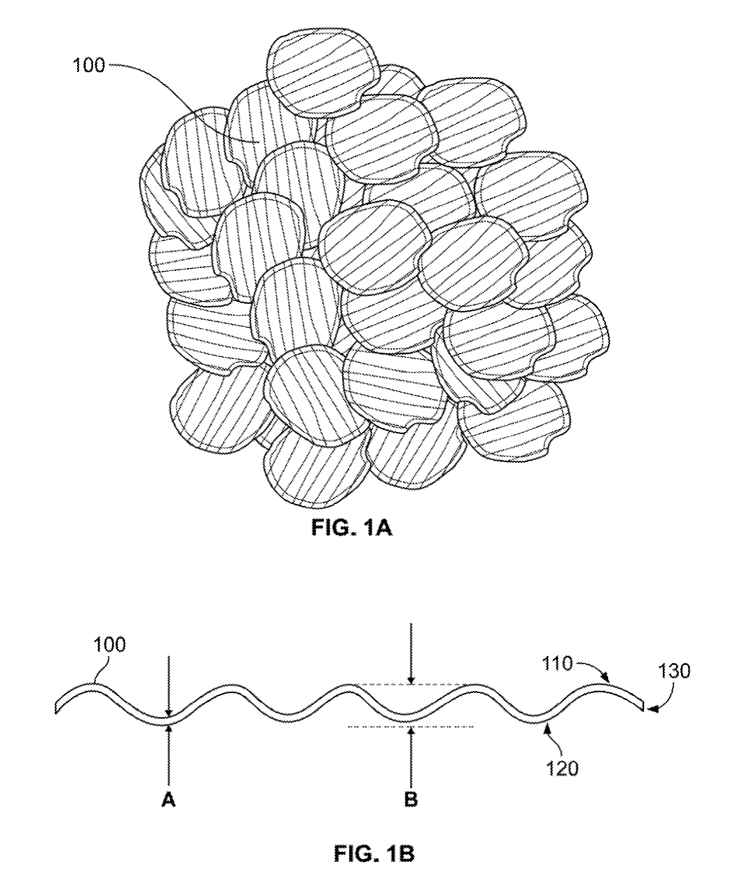

FIG. 1A shows exemplary crisp meat chips 100 according to the present invention. FIG. 1B is a sideview of a crisp meat chip 100 according to the present invention. The crisp meat chips are comprised of a baked meat-based mixture consisting of water, meat and liquid or dry ingredients. The meat included in the mixture is preferably chicken or ham. It should be appreciated that other meats including pork, turkey, beef or other meats may be used in the mixture and comprise the meat chip. In certain embodiments, the dry ingredients are salt, sodium phosphate, sodium nitrite, sodium erythorbate, and natural flavors and spices. Such dry ingredients may also include sweeteners such as sugar, corn syrup solids and dextrose. In a preferred embodiment, the mixture is between 90-98% meat, 1-8% water and 1-8% dry ingredients.

The meat chips have two opposed surfaces 110, 120 and a circumferential edge 130 connecting the two opposed surfaces. The first surface 110 and the second surface 120 are each rippled, the ripples on the first surface 110 and second surface 120 are generally aligned and parallel to one another to maintain an overall consistent thickness of the chip. The thickness between the first surface and the second surface of the chips, shown in FIG. 1B as distance “A,” is approximately 0.03-0.15 inches prior to cooking and drying. After cooking and drying, the thickness is approximately 0.01-0.05 inches. However, due to surface height variation caused by the ripples, the overall distance between raised portions of the first surface and the raised portions of the second surface, illustrated in FIG. 1B as dimension “B,” is greater than 0.069 inches prier to cooking and drying.

In the preferred embodiment shown in FIG. 1A, the crisp chips have a diameter of approximately 1.15-2.3 inches prior to cooking and drying. That diameter shrinks to approximately 0.75-1.50 inches after cooking and drying. Also, in a preferred embodiment, the crisp meat chips have approximately 3 and ⅓ ripples per inch and with a ripple depth of 0.080 inches, prior to drying and cooking. After drying and cooking, the chips have approximately 4.9 ripples per inch and a ripple depth of approximately 0.045 inches. However, other ripple depths and ripples per inch may be used.

As discussed in more detail below concerning the process for making meat chips, the chips are baked, rather than fried in oil, resulting in a chip that has a relatively low fat and high protein profile. In particular, the crisp meat chips that are made from ham according to the present invention have approximately 5 g fat and 18 g protein per ounce, but can range from 1-7 g fat and 12-23 g protein. The crisp meat chips that are made from chicken have approximately 7 g fat and 18 g protein per ounce, but can range from 1-7 g fat and 15-23 g protein. These ratios can be adjusted by the selection of raw materials as well as the amount of drying applied to the chips, which removes moisture.

The crisp meat chips according to the present invention also have a rigidity and crispness that distinguishes them from jerky or other conventional dried meat products. The crispness of the meat chip results in a snack food that fractures when bitten, rather than merely being primarily torn or ground when being bitten into. The crispness also creates a desirable mouth-feel. The mechanical properties of the meat chips that result in this desirable crispness fracture when displaced approximately 0.5 to 3.0 mm, under 200 to 600 grams of force applied using a ¼ inch rounded end probe.

The crisp meat chips are also shelf-stable at ambient temperatures due in part to their low moisture content. The meat chips according to the invention have a moisture content of approximately 0.2-3.0 g per ounce.

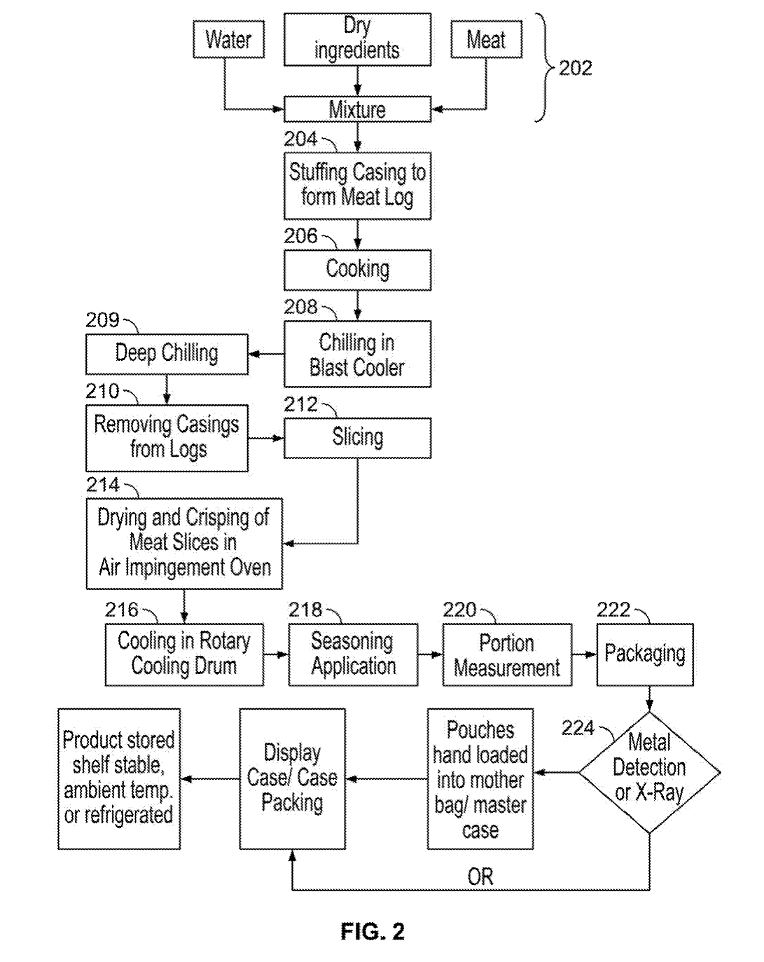

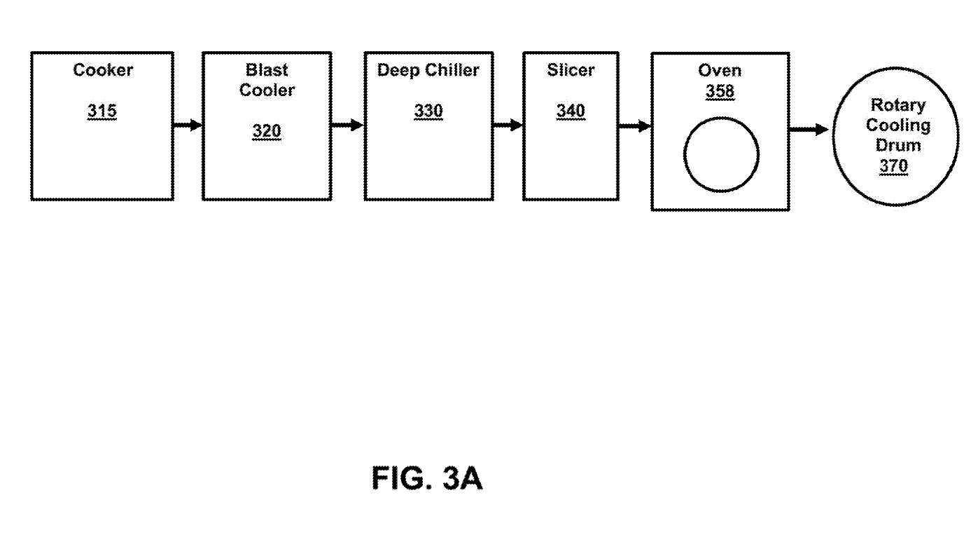

FIG. 2 shows a flow chart illustrating a method for making a meat chip according to the present invention. FIG. 3 shows a schematic representation of a system used to make the meat chip including the equipment comprising that system.

A meat log is created in the first steps of the process. First, a mixture of finely chopped meat, water and liquid or dry ingredients are combined. Step 202. The chopped meat is preferably chicken or ham. But it should be appreciated that other meats including pork, turkey, beef or other meat may be used in the mixture. Alternatively, a combination of meats may be used in the mixture. The meat mixture is comprised of between 90-98% meat, 1-8% water and 1-8% dry ingredients.

The meat mixture is then stuffed into a container such as a casing or other form. Step 204. In a preferred embodiment, a casing having a 0.75-1.50″ diameter is used. The casings may be either natural or man-made casings, including plastic, fibrous, or cellulose casings. In an alternative embodiment, forms such as an open topped metal tray or the like may be used, but such forms will result in an irregular, non-uniform, non-circular chip.

Once the meat mixture is stuffed into the casing, the mixture stuffed in the casings is cooked. Step 206. In particular the mixture is cooked 315 until it reaches a prescribed internal temperature. For chicken-based meat mixtures, the prescribed internal temperature is 165 degrees Fahrenheit. For ham-based meat mixtures, the prescribed internal temperature is 160 degrees Fahrenheit. The cooking process cooks and solidifies the meat mixture such that the meat mixture is cooked into a solid cohesive meat log. The cooking process may include a number of cook cycles, including for example a first 60 minute cook cycle under steam and a wet bulb at 130 degrees Fahrenheit, followed by a second 60 minute cook cycle under steam and a wet bulb at 160 degrees Fahrenheit, followed by a third cook cycle under steam and a wet bulb at 185 degrees Fahrenheit until the product reaches the prescribed internal temperature, followed by a shower cycle for 25 minutes. In certain embodiments, the cooking step may take place in a smokehouse.

Once the cooking step has been completed, the meat logs are rapidly cooled to an internal temperature of 40 degrees Fahrenheit. Step 208. The meat logs are preferably rapidly cooled using a blast cooler 320. In addition forced air may be used to speed up the rapid cooling process.

The meat logs are then deep-chilled to a temperature of approximately 20-22 degrees Fahrenheit using a deep chiller 330. Step 209. In certain embodiments, the deep chiller is a mechanical freezer with a slow moving belt onto which the meat logs are placed. The mechanical freezer is set to approximately negative 22 degrees Fahrenheit and the meat logs are chilled as they travel through the deep chiller via the conveyor. However, it will be appreciated that other conventional freezers for deep chilling could be used. The deep chilling of the meat logs permits the slices to be sliced sufficiently thin, which is important to create a crisp chip, without tearing or degradation during the slicing process described below. Deep chilling also helps generate consistent thickness in the meat slices, which negatively affects the drying process and consistency between the resultant meat chips, as well as reduce fines.

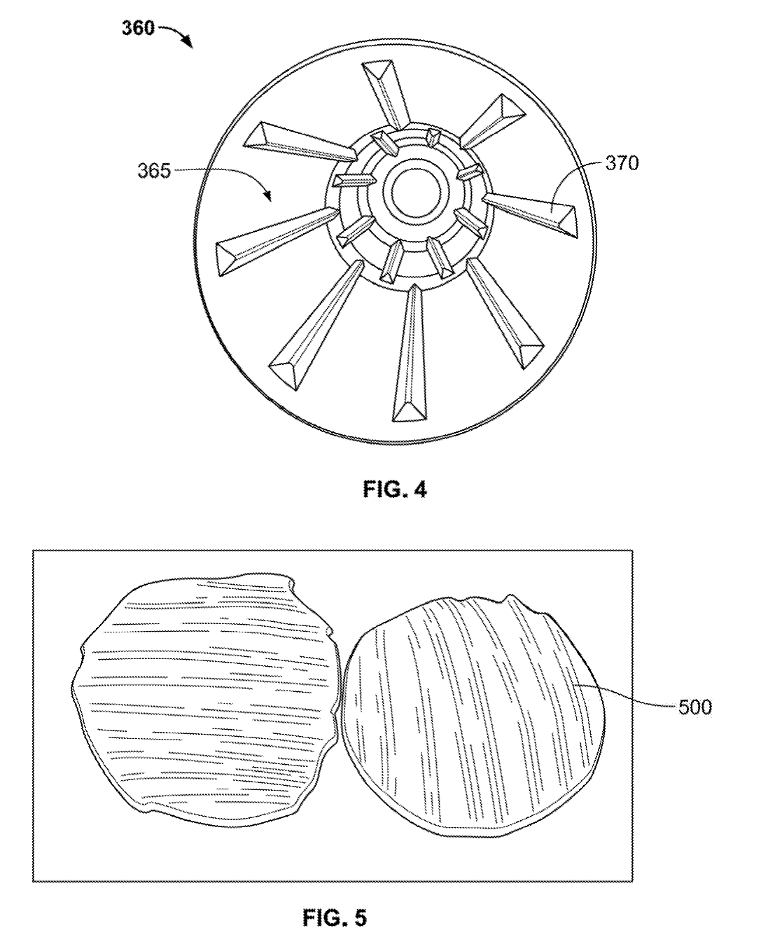

After the meat logs are deep chilled, the casings are removed from the meat logs. Step 210. After the casings are removed, the meat logs are then sliced into ripple cut slices using a slicer 340. Step. 212. FIG. 5 shows exemplary meat slices 500 before drying and crisping. Such slices preferably have a thickness of approximately 0.03-0.15 inches. During the slicing process the meat logs are prevented from rotating about their longitudinal axis or from shifting from side to side so that the ripples on each side of the slice are aligned and parallel to one another. Such ripple cut slicing may be accomplished using a commercially available slicer such as the E-Translicer by Urschel. However, other similar slicers may be used in accordance with the present invention. The slicing may be achieved at a blade speed of approximately 2200 hz and a belt speed of 2000 hz.

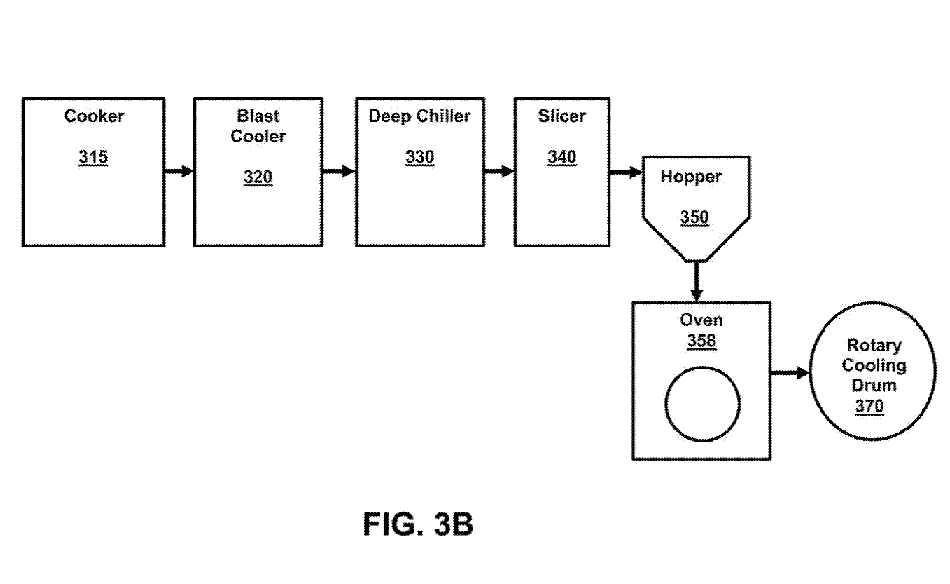

After slicing, the meat slices are conveyed into an oven for drying and crisping. The oven is an air impingement oven 358. Step 214. Forced air flowing inside of the oven also moves the meat slices during the drying and crisping process to further aid in even heating of the meat slices and to prevent meat slices from sticking together. The meat slices are dried and crisped in the oven at an oven temperature between 250-450 degrees Fahrenheit, for approximately 15-60 min, at an air flow of approximately 250-500 ft/min. Depending upon the size of the oven, the output of the process can be approximately 500 lbs/hr. In certain embodiments, the oven may be a rotary air impingement oven 360, as shown in FIG. 4, that has a drum 365 that rotates about a horizontal axis. In such embodiments, the meat slices are dried and crisped inside of a drum 365 while the drum rotates. Baffles or ridges 370 inside of the drum 365 tumble the sliced meat while it is dried and crisped, thereby ensuring even heat distribution and preventing the meat slices from sticking.

Advantageously, drying and crisping the meat slices by the air impingement oven 358 at the prescribed settings produces a fully dried, crisp chip without the need for an additional frying or microwaving step. Microwaving can negatively alter the quality and flavor of the meat. Frying can both negatively alter the quality and flavor of the meat as well as its nutritional content. When a low-fat meat mixture, such as the chicken-based or ham-based mixture described above, is dried and crisped via the air impingement oven at the prescribed settings, it also avoids the need to have a fat-draining means, such as an open conveyer, during the drying and crisping step.

After drying and crisping, the meat chips are then cooled to ambient temperature of approximately 70 degrees. Step 216. This cooling step is preferably performed by tumbling the meat chips in a rotary cooling drum 370 during which the tumbling facilitates air flow over the chips and enhances heat exchange to cool the chips.

As shown in FIG. 3B, in certain embodiments, after slicing, the meat slices are sliced they are placed into a hopper 350 that fluffs the slices so that they do not stick together prior to the drying and crisping step. The hopper may apply vibration or forced air, or a combination of both vibration and forced air, to the slices to keep the slices separated and from sticking to one another prior to drying and crisping. The hopper then loads the slices into the impingement oven 358.

As shown in FIG. 2, optionally, after cooling the chips, the chips may be seasoned by applying seasoning inside the rotary cooling drum 370. Step 218. The tumbling of the meat chips with the seasoning facilitates even seasoning distribution without the need for transferring the meat chips to a seasoning station.

Also, optionally, after cooling the meat chips may be measured, Step 220, and packaged. Step 222. The meat chips may be weighted using a rotary scale to the desired portion for packaging and deposited into the packaging. In certain preferred embodiments, the packaging may be a sealable pouch that has been purged with nitrogen prior to being filled with the meat chips. After filling, the packaging is sealed closed. In certain embodiments, the packaging may be processed through a metal detector or x-rayed to ensure quality of the packaged product. Step 224.

It should be emphasized that the above-described embodiments, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and protected by the following claims.

We claim:

1. A crisp meat chip comprising:
a first rippled surface;
a second rippled surface opposite the first rippled surface;
a circumferential edge connecting the first surface and the second surface;
a thickness between the first surface and the second surface of approximately 0.01-0.05 inches; and
wherein the chip fractures when displaced approximately 0.5 to 3.0 mm under 200 to 600 grams of force applied using a ¼ inch rounded end probe.

2. A crisp meat chip comprising:
a first rippled surface;
a second rippled surface opposite the first rippled surface;
a circumferential edge connecting the first surface and the second surface; and
an approximately consistent thickness between the first surface and the second surface of approximately 0.01-0.05 inches;
wherein the crisp meat chip contains approximately 12 to 23 grams protein per ounce and approximately 1 to 7 grams of fat per ounce.

3. A crisp meat chip comprising:
a first side having as first rippled surface;
a second side having a second rippled surface;
a circumferential edge connecting the first surface and the second surface;
wherein the crisp meat chip contains approximately 12 to 23 grams protein per ounce, approximately 1 to 7 grams of fat per ounce and approximately 2.6 grams of moisture per ounce.

4. A method for making crisp meat chips comprising:
creating a meat log;
cooking the meat log;
cooling the cooked meat log to approximately 40 degrees Fahrenheit;
deep chilling the meat log to 20-22 degree Fahrenheit;
slicing the meat log into rippled meat slices;
drying the meat slices using an air impingement oven; and
cooling the meat slices.

5. The method of claim 4 wherein the rippled meat slices are approximately 0.03-0.15 inches thick.

6. The method of claim 4 wherein the air impingement oven used to dry the meat slices dries the meat slices between 250 to 450 degrees Fahrenheit and for approximately 15-60 minutes.

7. The method of claim 4 wherein the air impingement oven used to dry the meat slices dries the meat slices at an airflow between 250 to 500 feet per minute.

8. The method of claim 4 wherein the air impingement oven is a rotary air impingement oven.

9. The method of claim 4 wherein the cooking the meat log occurs in a smokehouse.

10. A method for making crisp meat chips comprising:
creating a meat log, wherein the meat log is created by filling a casing with a meat-based mixture;
cooking the meat log to an internal temperature of approximately 160 to 165 degrees Fahrenheit;
cooling the cooked meat log to approximately 40 degrees Fahrenheit;
deep chilling the meat log to approximately 20 to 22 degree Fahrenheit;
removing the casing from the meat log;
slicing the meat log into rippled meat slices;
drying the meat slices using an air impingement oven; and
cooling the meat slices in a rotary cooling drum.

11. The method for making crisp meat chips of claim 10 wherein the rotary drum air impingement oven dries the meat slices between 250 to 450 degrees Fahrenheit and for approximately 15-60 minutes.

12. The method for making crisp meat chips of claim 10 wherein the air flow in the air impingement oven during drying the meat chips is between 250 to 500 feet per minute.

13. The method for making crisp meat chips of claim 10 wherein the mixture is comprised of between 90 to 98% meat, 1 to 8% water and 1 to 8% dry ingredients.

14. The method of making crisp meat chips of claim 10 wherein the cooking step is performed in a smokehouse.

15. A rippled crisp meat chip approximately 0.01-0.05 inches thick, and wherein the chip fractures when displaced approximately 0.5 to 3.0 mm under 200 to 600 grams of force applied using a ¼ inch rounded end probe, produced by a process comprising the following steps:
creating a meat log by filling a casing with a mixture comprised of meat, water and liquid or dry materials;
cooking the meat log;
cooling the cooked meat log to approximately 40 degrees Fahrenheit;
deep chilling the meat log to approximately 20 to 22 degrees Fahrenheit;
removing the casing from the meat log;
slicing the meat log into rippled meat slices approximately 0.03-0.15 inches thick;
drying the meat slices using an air impingement oven; and
cooling the meat slices in a rotary cooling drum.

16. The rippled crisp meat chip of claim 15 wherein the crisp meat chip contains approximately 12 to 21 grams protein per ounce and approximately 1 to 7 grams of fat per ounce.

17. The rippled crisp meat chip of claim 15 wherein the crisp meat chip contains approximately 0.2-3.0 grams moisture per ounce.

18. The rippled crisp meat chip of claim 15 wherein the mixture is comprised of between 90 to 98% meat, 1 to 8% water and 1 to 8% dry ingredients.

19. The rippled crisp meat chip of claim 15 wherein the air impingement oven used to dry the meat slices dries the meat slices at 250 to 450 degrees and for approximately 15-60 minutes.
